(19) United States
(12) Patent Application Publication
(10) Pub. No.: US 2025/0296727 A1
(43) Pub. Date: Sep. 25, 2025

(54) Carton With Locking Features

(71) Applicant: Graphic Packaging International, LLC, Atlanta, GA (US)

(72) Inventor: Steven M. Oliveira, Canton, GA (US)

(21) Appl. No.: 19/084,935

(22) Filed: Mar. 20, 2025

Related U.S. Application Data
(60) Provisional application No. 63/567,481, filed on Mar. 20, 2024.

(51) Int. Cl. B65D 5/38; B31B 50/26; B31B 50/84; B31B 105/00; B31B 120/60; B65D 5/54; B65D 5/72

(52) U.S. Cl. CPC B65D 5/38; B31B 50/262; B31B 50/84; B65D 5/5415; B65D 5/725; B31B 2105/00; B31B 2120/60

(57) ABSTRACT

A carton for holding one or more products. The carton can comprise an inner part comprising an inner locking structure and an inner stop structure and an outer part comprising an outer locking structure and an outer stop structure. The carton also can comprise a dispenser extending in the inner part. The inner locking structure and the outer locking structure can cooperate to limit movement between the inner part and the outer part when the inner part is in a first position. At least the inner locking structure can be moveable with respect to the outer locking structure for allowing the inner part to move relative to the outer part from the first position to a second position. The inner stop structure and the outer stop structure can cooperate to limit movement of the inner part when the inner part is in the second position.

### CROSS-REFERENCE TO RELATED APPLICATIONS

This application claims the benefit of U.S. Provisional Patent Application No. 63/567,481, filed on Mar. 20, 2024.

### INCORPORATION BY REFERENCE

The disclosures of U.S. Provisional Patent Application No. 63/547,697, which was filed on Nov. 8, 2023, and U.S. Provisional Patent Application No. 63/567,481, which was filed on Mar. 20, 2024, are hereby incorporated by reference for all purposes as if presented herein in their entirety.

### BACKGROUND OF THE DISCLOSURE

The present disclosure generally relates to cartons for holding and dispensing products and to methods of forming the cartons. More specifically, the present disclosure is directed to cartons with locking features for holding the cartons in a closed configuration.

Cartons with locking features can be used for a wide variety of different products, such as dishwashing and/or laundry agents, medicines, household cleaners, candles, cosmetics, tobacco, and other products that should be kept out of the hands of children, as they may put the products in their mouths, swallow them, or use them in other dangerous ways.

### SUMMARY OF THE DISCLOSURE

In general, one aspect of the disclosure is directed to a carton for holding one or more products. The carton can comprise an inner part comprising a plurality of inner panels extending at least partially around an interior of the inner part. The plurality of inner panels can comprise at least a first inner side panel and a second inner side panel opposite to the first inner side panel. The inner part further can comprise an inner locking structure foldably connected to the first inner side panel and an inner stop structure foldably connected to the second inner side panel. The carton also can comprise an outer part comprising a plurality of outer panels extending at least partially around at least a portion of the inner part. The plurality of outer panels can comprise at least a first outer side panel and a second outer side panel. The outer part further can comprise an outer locking structure foldably connected to the first outer side panel and an outer stop structure foldably connected to the second outer side panel. The carton also can comprise a dispenser extending in the inner part. The dispenser can be configured for being actuated to provide access to the interior of the inner part. The inner locking structure and the outer locking structure can cooperate to limit movement between the inner part and the outer part when the inner part is in a first position. At least the inner locking structure can be moveable with respect to the outer locking structure for allowing the inner part to move relative to the outer part from the first position at least partially through an open end of the outer part to a second position. The inner stop structure and the outer stop structure can cooperate to limit movement of the inner part through the open end of the outer part when the inner part is in the second position.

In another aspect, the disclosure is generally directed to, in combination, a first blank and a second blank for cooperating to form a carton. The first blank can comprise a plurality of inner panels, an inner locking structure, and an inner stop structure. The plurality of inner panels can comprise at least a first inner side panel and a second inner side panel, and dispenser features can extend in the plurality of panels. The inner locking structure can be foldably connected to the first inner side panel and the inner stop structure can be foldably connected to the second inner side panel. The first blank can be for forming an inner part having an interior and the dispenser features can be for forming a dispenser in the inner part formed from the first blank. The second blank can comprise a plurality of outer panels, an outer locking structure, and an outer stop structure. The plurality of outer panels comprising at least a first outer side panel and a second outer side panel. The outer locking structure can be foldably connected to the first outer side panel and the outer stop structure can be foldably connected to the second outer side panel. The second blank can be for forming an outer part with the plurality of outer panels at least partially extending around the inner part formed from the first blank. The inner locking structure and the outer locking structure can be configured for cooperating to limit movement between the inner part formed from the first blank and the outer part formed from the second blank when the carton is formed from the first blank and the second blank and when the inner part formed from the first blank is in a first position. The inner stop structure and the outer stop structure can be configured for cooperating to limit movement of the inner part formed from the first blank relative to the outer part formed from the second blank when the carton is formed from the first blank and the second blank and when the inner part formed from the first blank is in a second position.

In another aspect, the disclosure is generally directed to a method of forming a carton. The method can comprise obtaining a first blank comprising a plurality of inner panels, an inner locking structure, and an inner stop structure. The plurality of inner panels can comprise at least a first inner side panel and a second inner side panel, and dispenser features can extend in the plurality of panels. The inner locking structure can be foldably connected to the first inner side panel and the inner stop structure can be foldably connected to the second inner side panel. The method further can comprise forming an inner part from the first blank by folding the plurality of inner panels at least partially around an interior of the inner part. The dispenser features can form a dispenser of the inner part, and the dispenser can be configured for being actuated to provide access to the interior of the inner part. The method also can comprise obtaining a second blank comprising a plurality of outer panels, an outer locking structure, and an outer stop structure. The plurality of outer panels can comprise at least a first outer side panel and a second outer side panel. The outer locking structure can be foldably connected to the first outer side panel and the outer stop structure can be foldably connected to the second outer side panel. The method further can comprise forming an outer part from the second blank. The inner part can be located at least partially within the outer part so that the outer panels extend at least partially around the inner part. The outer part can comprise a second opening. The inner locking structure and the outer locking structure can cooperate to limit movement between the inner part and the outer part when the inner part is in a first position. At least the inner locking structure is moveable with respect to the outer locking structure for allowing the inner part to move relative to the outer part from the first position at least partially through an open end of the outer part to a second position. The inner stop structure and the outer stop structure can cooperate to limit movement of the inner part through the open end of the outer part when the inner part is in the second position.

Additional aspects, features, and advantages of the present invention will become apparent from the following description and accompanying figures.

Those skilled in the art will appreciate the above stated advantages and other advantages and benefits of various additional embodiments reading the following detailed description of the embodiments with reference to the below-listed drawing figures. It is within the scope of the present disclosure that the above-discussed aspects be provided both individually and in various combinations.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the embodiments of the disclosure.

FIGS. 1 and 2 are plan views of a respective inner container blank and outer cover blank used for at least partially forming a respective inner container part and outer cover part of a carton according to exemplary embodiments of the disclosure.

FIG. 3 is a plan view of the blank of FIG. 1 after folding of locking features of the blank according to the exemplary embodiments of the disclosure.

FIG. 4 is a perspective view of the inner container part formed from the blank of FIGS. 1 and 3 according to the exemplary embodiments of the disclosure.

FIG. 5 is a plan view of the blank of FIG. 2 after folding of locking features of the blank according to the exemplary embodiments of the disclosure.

FIGS. 6 and 7 are perspective views of the outer cover part formed from the blank of FIGS. 2 and 5 according to the exemplary embodiments of the disclosure.

FIG. 8 is a perspective view of a carton including the inner container part of FIG. 4 and the outer cover part of FIGS. 6 and 7 according to the exemplary embodiments of the disclosure.

FIG. 9 is a perspective view showing the opening of the carton of FIG. 8 according to the exemplary embodiments of the disclosure.

FIGS. 10A and 10B are side elevation views of the carton of FIGS. 8 and 9 in the open configuration according to the exemplary embodiments of the disclosure.

FIG. 11 is a perspective view of the carton of FIGS. 8-10B in the open configuration and showing an opened dispenser of the inner part of the carton according to the exemplary embodiments of the disclosure.

Corresponding parts are designated by corresponding reference numbers throughout the drawings.

### DETAILED DESCRIPTION OF THE EXEMPLARY EMBODIMENTS

The present disclosure generally relates to constructs, boxes, cartons, carriers, trays, or the like, and packages for holding one or more products or articles such as those that should be kept out of the hands of children (e.g., for safety reasons). The product or products can be cleaning products such as laundry pods, dishwashing agents, household cleaners, soaps, and the like; cat litter and/or other suitable granular and/or flowable materials; medicines; cosmetics; candles; tobacco; food items; objects that may pose a choking hazard; any other suitable product or material; or combinations thereof.

Cartons according to the present disclosure can accommodate product or articles of any shape. In this specification, the terms “inner,” “interior,” “outer,” “exterior,” “lower,” “bottom,” “upper,” and “top” indicate orientations determined in relation to fully erected and upright cartons. As described herein, cartons can be formed from blanks with multiple panels, flaps, portions, tabs, lines of weakening, edges, openings, and/or other suitable aspects, which may be designated herein in terms relative to one another, e.g., “first,” “second,” “third,” etc., in sequential or nonsequential reference, without departing from the disclosure.

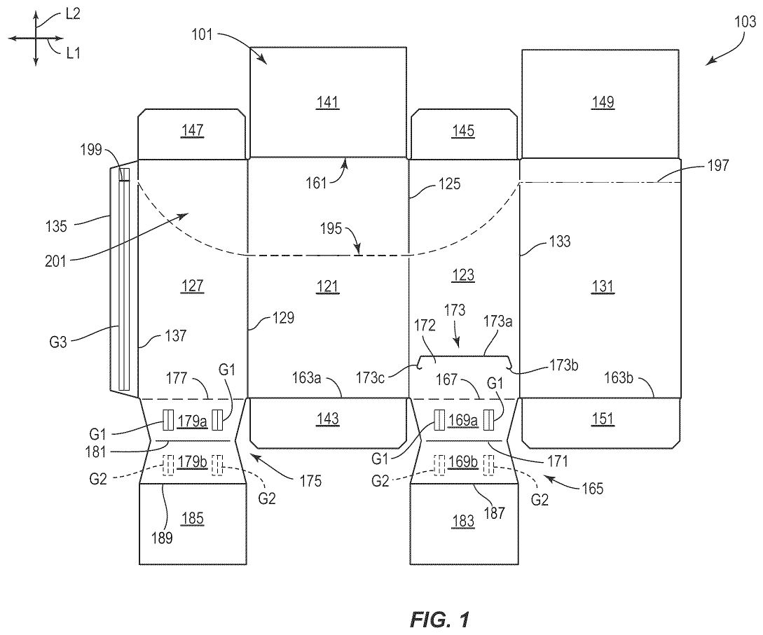

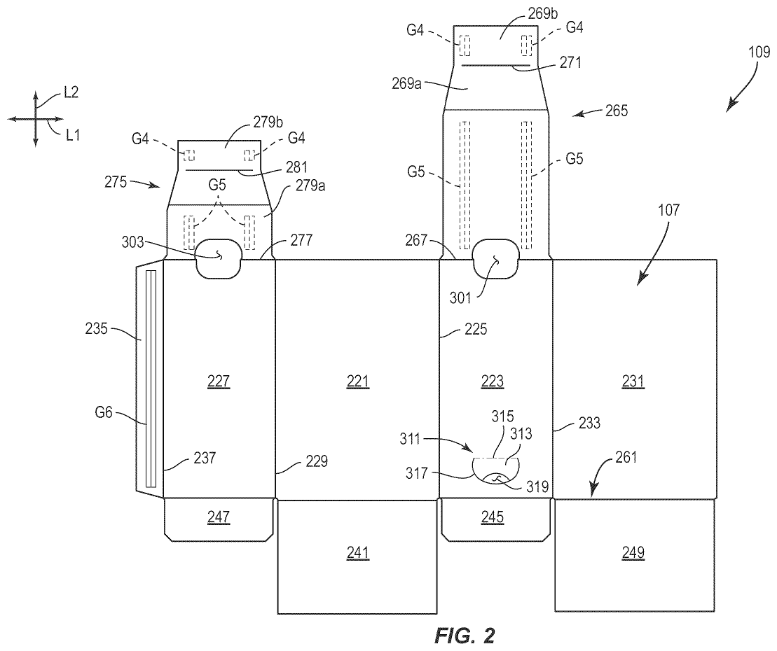

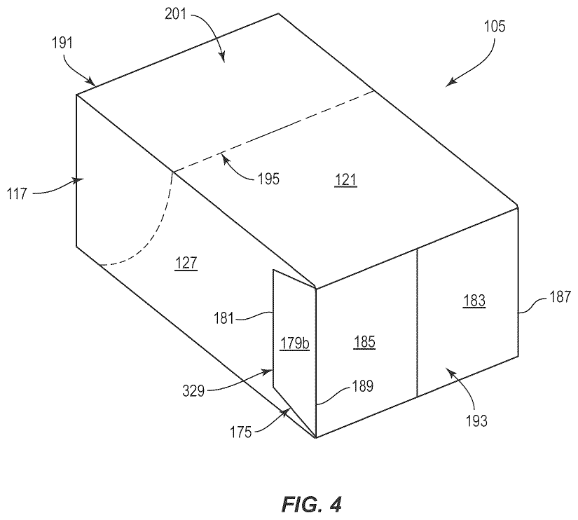

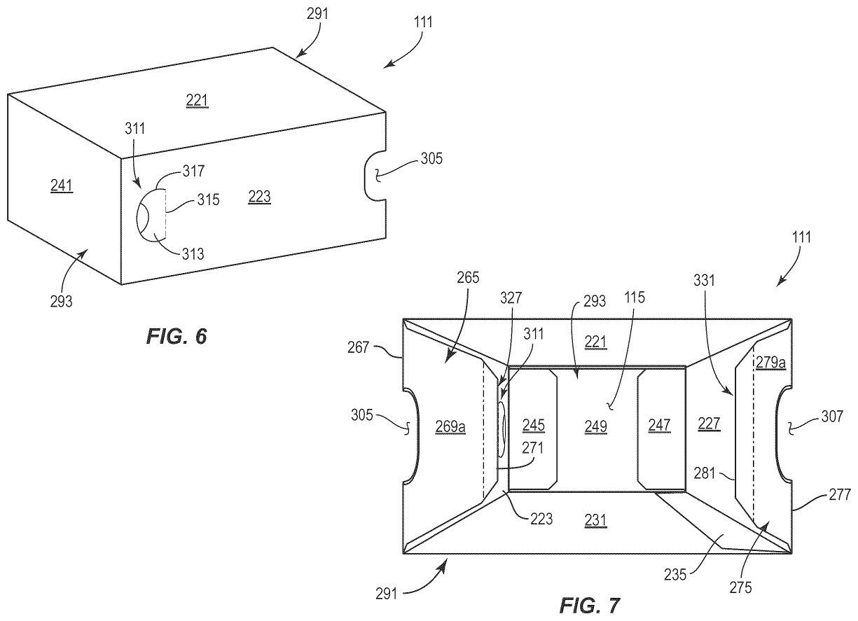

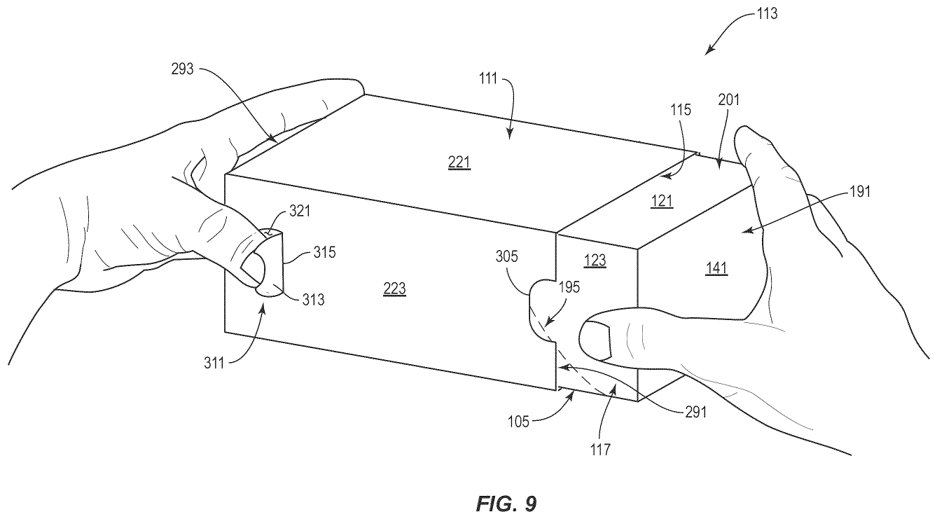

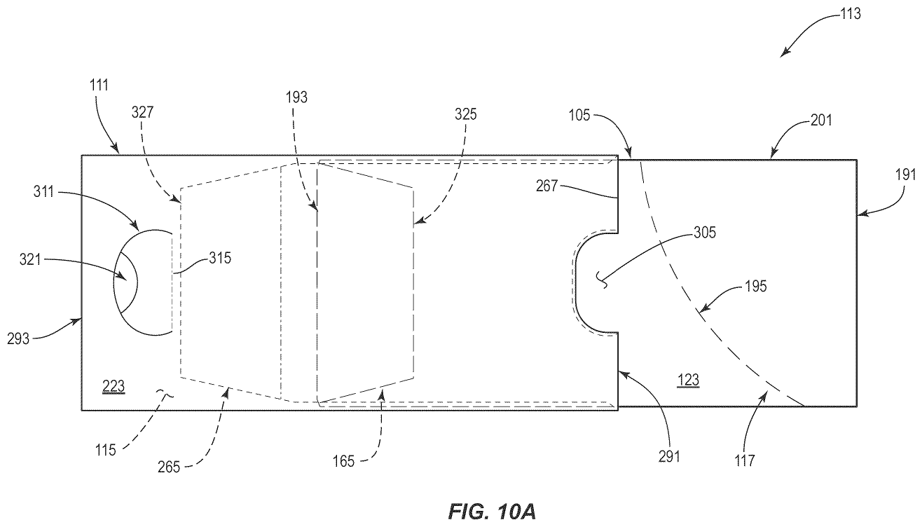

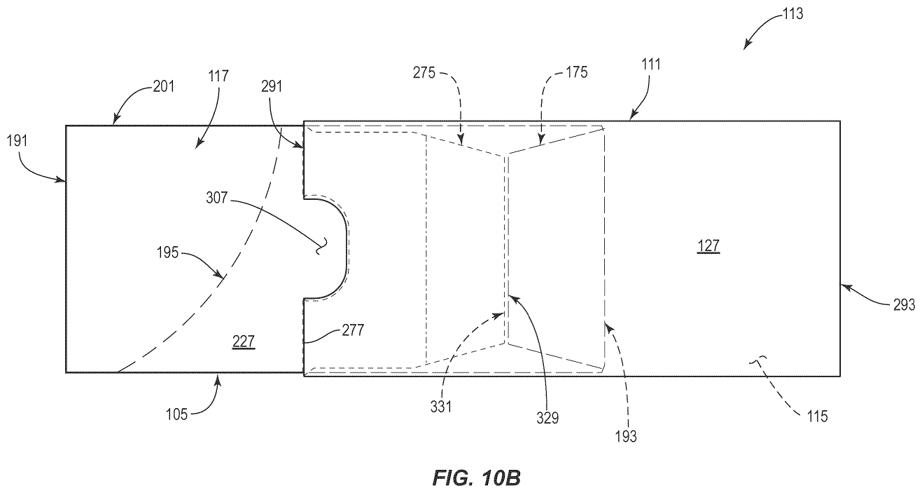

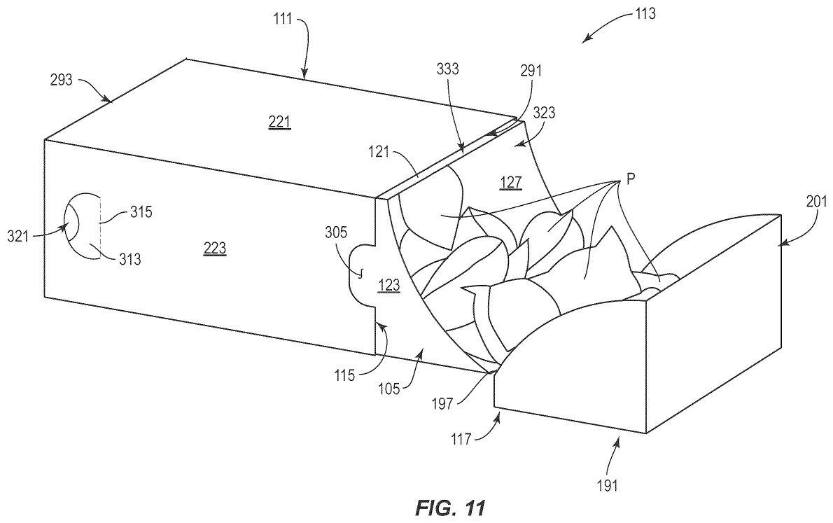

FIG. 1 illustrates an exterior surface 101 of a first or inner blank 103 for forming a first or inner part 105 (e.g., a first or inner construct 105) (FIGS. 4 and 8-11), which can at least partially form a container used to hold one or more products P (e.g., FIG. 11). FIG. 2 illustrates an exterior surface 107 of a second or cover or outer blank 109 used to form a second or cover or outer part 111 (e.g., a second or outer construct 111) (FIGS. 6-11). In the illustrated embodiments, the inner part 105 and the outer part 111 can cooperate to form a carton 113 (FIGS. 8-11) with the inner part 105 positioned at least partially within an interior 115 of the outer part 111. In embodiments, the inner part 105 and the outer part 111 can include locking features for resisting and/or preventing movement of the inner part 105 relative to the outer part 111 when the carton 113 is in a closed and locked configuration (e.g., the inner part 105 is in a first position) (FIG. 8). In exemplary embodiments, the locking features can be disengaged (FIGS. 9 and 10) so that the inner part 105 can be moved from its first position at least partially out of the interior 115 of the outer part 111 to a second position (FIGS. 10A-11), providing access to a dispenser 117 of the inner part 105 (FIG. 11). As shown in FIGS. 9-11, stop features of the carton can be configured to resist and/or prevent removal of the inner part 105 from the outer part 111 when the carton 113 is in the open configuration (e.g., the inner part 105 is in its second position) (FIGS. 10A-11). In embodiments, the dispenser 117 can be actuated when the carton 113 is in the open configuration to provide access to the product(s) P held in the inner part 105 (FIG. 11).

As shown in FIG. 1, the inner blank 103 has a longitudinal axis LI and a lateral axis L2. The inner blank 103 can include a plurality of inner panels that are foldably connected to one another along respective lateral fold lines. In exemplary embodiments, the inner blank 103 can include an inner front or top panel 121 foldably connected to a first inner side panel 123 along a first lateral fold line 125, a second inner side panel 127 foldably connected to the inner front panel 121 along a second lateral fold line 129, and an inner bottom panel 131 foldably connected to the first inner side panel 123 along a third lateral fold line 133. In embodiments, the inner blank 103 can include an inner attachment flap 135 foldably connected to the second inner side panel 127 along a fourth lateral fold line 137. Any of the inner panels 121, 123, 127, 131, 135 could be omitted or could be otherwise shaped, arranged, configured, and/or positioned without departing from the disclosure. For example, the inner attachment flap 135 could be foldably connected to the inner back panel 131 or could be omitted without departing from the disclosure.

The inner top panel 121 is foldably connected to a first inner top end flap 141 and a second inner top end flap 143. Each of the first inner side panel 123 and the second inner side panel 127 is foldably connected to a respective first inner side end flap 145, 147. The inner bottom panel 131 is foldably connected to a first inner bottom end flap 149 and a second inner bottom end flap 151. The first inner end flaps 141, 145, 147, 149 extend along a first marginal area of the inner blank 103 and are foldably connected along a first longitudinal fold line 161 that extends along the length of the blank. The second inner end flaps 143, 157 extend along a second marginal area of the blank 103 and are foldably connected along respective second longitudinal fold lines 163a, 163b. The longitudinal fold lines 161, 163a, 163b may be, for example, substantially straight, offset, and/or oblique at one or more locations to account for blank thickness and/or for other factors.

In the illustrated embodiments, the inner blank 103 can include inner locking features. For example, the inner blank 103 can include an inner locking structure 165 foldably connected to the first inner side panel 123 along a longitudinal fold line 167. As shown in FIG. 1, the inner locking structure 165 can include a first or proximal inner locking panel 169a foldably connected to the first inner side panel 123 along the longitudinal fold line 167 and a second or distal inner locking panel 169b foldably connected to the proximal inner locking panel 169a along a longitudinal fold line 171. As shown in FIG. 1, an inner side tab 172 can extend in the first inner side panel 123 and can be at least partially aligned with the inner locking structure 165. In embodiments, the inner side tab 172 can be at least partially defined by a cut 173 (or other suitable line of weakening) extending in the first inner side panel 123. For example, the cut 173 can include a longitudinal central portion 173a extending from an oblique end portion 173b to an oblique end portion 173c. In the illustrated embodiments, the end portions 173b, 173c can include curved ends, which can act as tear stops.

In embodiments, the inner locking features of the inner blank 103 also can include an inner stop structure 175 foldably connected to the second inner side panel 127 along a longitudinal fold line 177. As shown in FIG. 1, the inner stop structure 175 can include a first or proximal inner stop panel 179a foldably connected to the second inner side panel 127 along the longitudinal fold line 177 and a second or distal inner stop panel 179b foldably connected to the proximal inner stop panel 179a along a longitudinal fold line 181. In embodiments, the inner locking structure 165 of the inner part 105 formed from the inner blank 103 can cooperate with locking features in the outer part 111 formed from the outer blank 109 to at least partially lock the carton 113 in a closed position and the inner stop structure 175 of the inner part 105 can cooperate with stop features in the outer part 111 to at least partially retain the inner part 105 in engagement with the outer part 111 when the carton 113 is in an open configuration, as described in more detail below. In exemplary embodiments, the inner locking structure 165 and the inner stop structure 175 can have a similar or identical size and/or shape. For example, the inner locking structure 165 and the inner stop structure 175 can have a similar or identical length (e.g., as measured from the respective fold lines 167, 177 in the lateral direction L2). The inner locking structure 165, the inner side tab 172, the cut 173, and/or the inner stop structure 175 could be omitted or could be otherwise shaped, arranged, configured, and/or positioned without departing from the disclosure.

In the illustrated embodiments, second inner side end flaps 183, 185 can be foldably connected to the respective inner locking structure 165 and inner stop structure 175 along respective longitudinal fold lines 187, 189. For example, the second inner side end flaps 183, 185 can be foldably connected to the respective distal inner locking panel 169b and distal inner stop panel 179b opposite to the respective inner side panels 123, 127. When the inner part 105 is erected, the first inner end flaps 141, 145, 147, 149 can at least partially close a first inner end 191 of the inner part, and the second inner end flaps 143, 151, 183, 185 can at least partially close a second inner end 193 of the inner part (FIGS. 4, 8, and 9). In accordance with alternative embodiments, different flap arrangements and/or fold line configurations can be used for closing the inner ends 191, 193 of the inner part 105.

As shown in FIG. 1, the inner blank 103 can include dispenser features for at least partially forming the dispenser 117 in the inner part 105. For example, the dispenser features can include a tear line 195 extending in at least the inner top panel 121 and the inner side panels 123, 127 (e.g., with a longitudinal segment extending in the inner top panel 121 and with at least partially curved segments extending in the respective inner side panels 123, 127). As shown in FIG. 1, the dispenser features further can include a longitudinal fold line 197 extending in the bottom panel 131 from an end of the tear line 195 at the lateral fold line 133 to a free edge of the inner blank 103 and a longitudinal fold line 199 extending in the attachment flap 135 from an end of the tear line 195 to a free edge of the inner blank 103. In embodiments, the longitudinal fold lines 197, 199 can be aligned along the longitudinal direction LI. As shown in FIG. 1, the tear line 195 and the longitudinal fold lines 197, 199 can at least partially define a dispenser structure 201 of the inner blank 103 and the inner part 105. For example, the dispenser structure 201 can include at least the first inner end flaps 141, 145, 147, 149, the portions of the inner top panel 121 and the inner side panels 123, 127 extending between the longitudinal fold line 161 and the tear line 195, the portion of the inner bottom panel 131 extending between the longitudinal fold lines 161, 197, and a portion of the inner attachment flap 135 defined by the longitudinal fold line 199. Any of the tear line 195, the fold lines 197, 199, and/or the dispenser structure 201 could be omitted or could be otherwise shaped, arranged, configured, and/or positioned without departing from the disclosure.

As shown in FIG. 2, the outer blank 109 can have a longitudinal axis L1 and a lateral axis L2 (e.g., corresponding to the axes L1, L2 of FIG. 1). The outer blank 109 can include a plurality of outer panels that are foldably connected to one another along respective lateral fold lines. In exemplary embodiments, the outer blank 109 can include an outer front or top panel 221 foldably connected to a first outer side panel 223 along a first lateral fold line 225, a second outer side panel 227 foldably connected to the outer front panel 221 along a second lateral fold line 229, and an outer bottom panel 231 foldably connected to the first outer side panel 223 along a third lateral fold line 233. In embodiments, the outer blank 109 can include an outer attachment flap 235 foldably connected to the second outer side panel 227 along a fourth lateral fold line 237. Any of the outer panels 221, 223, 227, 231, 235 could be omitted or could be otherwise shaped, arranged, configured, and/or positioned without departing from the disclosure. For example, the outer attachment flap 235 could be foldably connected to the inner back panel 231 or could be omitted without departing from the disclosure.

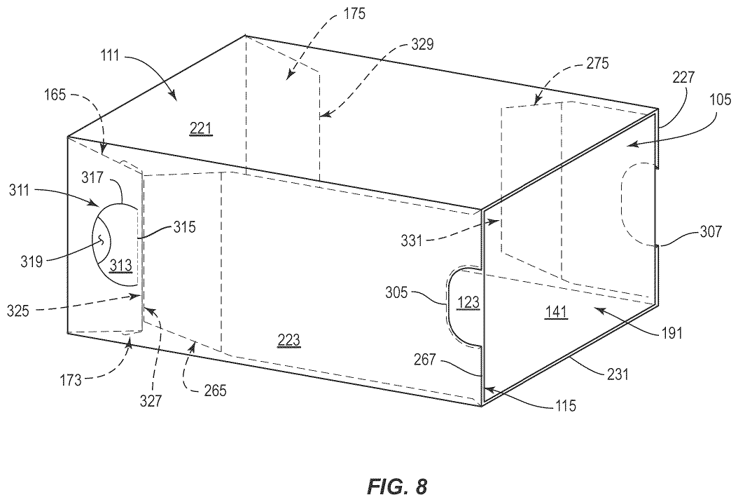

The outer top panel 221 is foldably connected to an outer top end flap 241, each of the first outer side panel 223 and the second outer side panel 227 is foldably connected to a respective outer side end flap 245, 247, and the outer bottom panel 231 is foldably connected to an outer bottom end flap 249. The outer end flaps 241, 245, 247, 249 extend along a first marginal area of the outer blank 109 and are foldably connected along a first longitudinal fold line 261 that extends along the length of the blank. The longitudinal fold line 261 may be, for example, substantially straight, offset, and/or oblique at one or more locations to account for blank thickness and/or for other factors. In embodiments, the first end 291 of the outer part 111 can be at least partially open when the outer part 111 is erected (FIGS. 7-11). When the outer part 111 is erected, the outer end flaps 241, 245, 247, 249 can at least partially close a second outer end 293 of the outer part (FIGS. 6 and 7). In accordance with alternative embodiments, different flap arrangements and/or fold line configurations can be used for closing the second end 293 of the outer part 111.

In the illustrated embodiments, the outer blank 109 can include outer locking features. For example, the outer blank 109 can include an outer locking structure 265 foldably connected to the first outer side panel 223 along a longitudinal fold line 267. As shown in FIG. 2, the outer locking structure 265 can include a first or proximal outer locking panel 269a foldably connected to the first outer side panel 223 along the longitudinal fold line 267 and a second or distal outer locking panel 269b foldably connected to the proximal outer locking panel 269a along a longitudinal fold line 271.

In embodiments, the outer locking features of the outer blank 109 also can include an outer stop structure 275 foldably connected to the second outer side panel 227 along a longitudinal fold line 277. As shown in FIG. 2, the outer stop structure 275 can include a first or proximal outer stop panel 279a foldably connected to the second outer side panel 227 along the longitudinal fold line 277 and a second or distal outer stop panel 279b foldably connected to the proximal outer stop panel 279a along a longitudinal fold line 281. In embodiments, the outer locking structure 265 of the outer part 111 formed from the outer blank 109 can cooperate with the inner locking structure 165 of the inner part 105 to at least partially lock the carton 113 in a closed position and the outer stop structure 275 of the outer part 111 can cooperate with inner stop feature 175 of the inner part 105 to at least partially retain the inner part 105 in engagement with the outer part 111 when the carton 113 is in an open configuration, as described in more detail below. In exemplary embodiments, the outer locking structure 265 and the outer stop structure 275 can have different sizes and/or shapes. For example, the inner locking structure 165 can be longer than the inner stop structure 175 (e.g., as measured from the respective fold lines 167, 177 in the lateral direction L2).

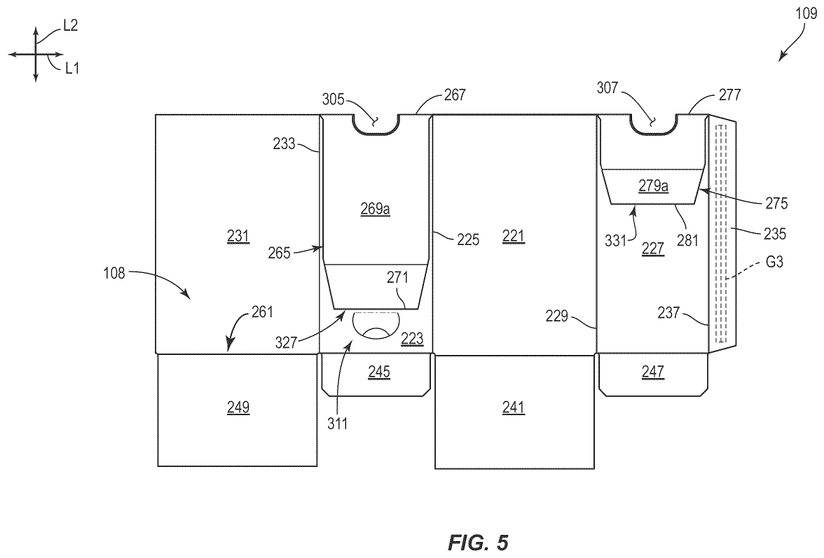

As shown in FIG. 1, the outer blank 109 can include two cutouts 301, 303 for forming respective access recesses 305, 307 (FIGS. 5-11) in the outer part 111. In embodiments, the access recesses 305, 307 can provide access to portions of the inner side panels 123, 127 for grasping the inner part 105 when the carton 113 is in the closed configuration (FIG. 8). In the illustrated embodiments, the cutout 301 can extend in the first outer side panel 223 and the proximal outer locking panel 269a of the outer locking structure 265 and the cutout 303 can extend in the second outer side panel 227 and the proximal outer stop panel 279a of the outer stop structure 275. In exemplary embodiments, the portions of the cutouts 301, 303 extending along respective edges of the proximal panels 269a, 279a can be slightly larger than the portions of the cutouts 301, 303 extending along respective edges of the outer side panels 223, 227.

In the illustrated embodiments, the outer blank 109 can include an access feature 311 extending in at least the first outer side panel 223. As shown in FIG. 1, the access feature 311 can include an access flap 313 foldably connected to the first outer side panel 223 along a longitudinal fold line 315 and at least partially separable from the first outer side panel 223 along an arcuate cut or tear line 317 and an access cutout 319. In embodiments, the access feature 311 can be opened by pulling the access flap 313 upwardly at the access cutout 319, separating the access flap 313 from the first outer side panel 223 along the acuate tear line 317 and folding the access flap 313 outwardly along the longitudinal fold line 315 to form an access opening 321 (FIG. 9). In exemplary embodiments, the access opening 321 can provide access to the inner locking structure 165 of the inner part 105 via the first outer side panel 223 when the carton 113 is in the closed configuration (FIG. 8). The outer locking structure 265, the outer stop structure 275, the cutouts 301, 303, and/or the access feature 311 could be omitted or could be otherwise shaped, arranged, configured, and/or positioned without departing from the disclosure.

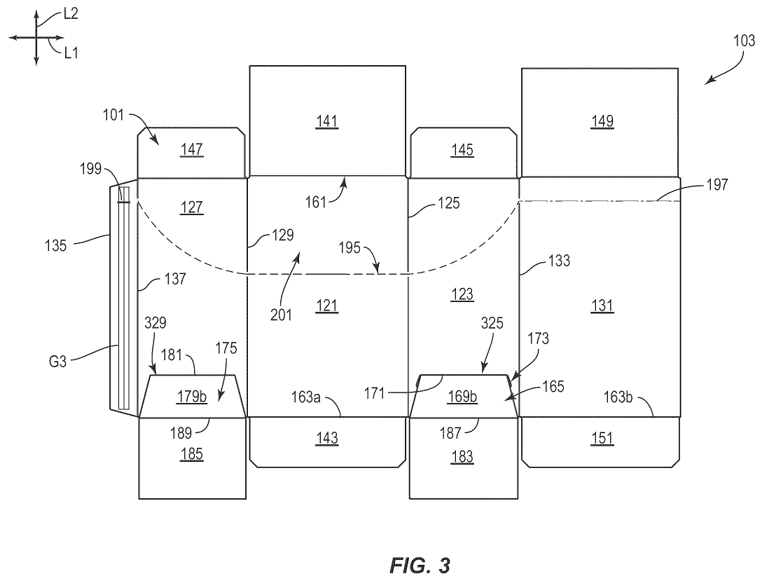

In exemplary embodiments, the inner part 105 can be formed from the inner blank 103 as shown in at least FIGS. 3 and 4. For example, as shown in FIG. 3, the inner locking structure 165 and the inner stop structure 175 can be folded (e.g., backfolded) along the respective longitudinal fold lines 167, 177 over the exterior surface 101 of the inner blank 103 (e.g., so that the proximal inner locking panel 169a and the proximal inner stop panel 179a are in face-to-face contact with the exterior surfaces of the respective inner side panels 123, 127). In embodiments, the proximal inner locking panel 169a and the proximal inner stop panel 179a can be secured (e.g., adhered) to the respective inner side panels 123, 127, such as with glue spots or glue strips G1 on the exteriors of the proximal inner locking panel 169a and the proximal inner stop panel 179a. As shown in FIG. 3, the distal inner locking panel 169b and the distal inner stop panel 179b can be folded along the respective longitudinal fold lines 171, 181 away from the inner side panels 123, 127 so that the interior surfaces of the distal inner locking panel 169b and the distal inner stop panel 179b are in face-to-face contact with the interior surfaces of the respective proximal inner locking panel 169a and proximal inner stop panel 179a. In embodiments, the distal inner locking panel 169b and the distal inner stop panel 179b can be secured (e.g., adhered) to the respective proximal inner locking panel 169a and proximal inner stop panel 179a, such as with glue spots or glue strips G2 on the interiors of the distal inner locking panel 169b and the distal inner stop panel 179b (and/or on the interiors of the proximal inner locking panel 169a and the proximal inner stop panel 179a). Accordingly, the inner locking structure 165 and the inner stop structure 175 are secured to respective inner side panels 123, 127 (e.g., via glue strips G1) on the exterior of the inner blank 103 and the proximal inner locking panel 169a and the proximal inner stop panel 179a are secured to the respective distal inner locking panel 169b and distal inner stop panel 179b (e.g., via glue strips G2).

As shown in FIG. 4, the inner part 105 further can be formed by folding the plurality of inner panels 121, 123, 127, 131 to extend at least partially around an interior space 323 (FIG. 11), which can hold the product P (FIG. 11). In exemplary embodiments, the inner attachment flap 135 can be attached (e.g., glued) in face-to-face contact with an interior surface of the inner bottom panel 131, such as with one or more glue strips G3 on the exterior surface of the inner attachment flap 135 and/or the interior surface of the inner bottom panel 131.

In the illustrated embodiments, the inner end flaps 141, 145, 147, 149 and 143, 151, 183, 185 can be folded and overlapped to at least partially close the inner ends 191, 193 of the inner part 105 (FIGS. 4, 8, and 9). As shown in FIGS. 8 and 9, the inner side end flaps 145, 147 can be folded over the first inner end 191 of the inner part 105, the inner bottom end flap 149 can be folded over the end to at least partially overlap the inner side end flaps 145, 147, and the inner top end flap 141 can be folded to overlap the inner bottom end flap 149. In embodiments, two or more of the inner end flaps 145, 147, 149, 141 can be secured (e.g., adhered) to one another. For example, the inner surface of the inner top end flap 141 can be glued and/or otherwise secured to the exterior surface of the inner bottom end flap 149. In the illustrated embodiments, the second inner end 193 of the inner part 105 can be closed by folding the second inner top end flap 143 and the second inner bottom end flap 151 along the longitudinal fold lines 163a, 163b and over the second inner end 193 and folding the second inner side end flaps 183, 185 along the respective longitudinal fold lines 187, 189 and to overlap the second inner top end flap 143 and the second inner bottom end flap 151. In embodiments, the second inner side end flaps 183, 185 can be glued and/or otherwise secured to the second inner top end flap 143 and the second inner bottom end flap 151. In exemplary embodiments, the product P can be loaded into the interior space 323 before or after closing either of the inner ends 191, 193 of the inner part 105. The inner part 105 could be otherwise formed and/or the inner ends 191, 193 could be otherwise closed without departing from the disclosure.

The inner part 105 with its closed inner ends 191, 193 is shown in FIGS. 4 and 8-11. In the illustrated embodiments, the inner locking structure 165 and the inner stop structure 175 are secured to the respective inner side panels 123, 127 on an exterior of the inner part 105. As shown in FIGS. 4 and 8-11, the dispenser 117 can be located at the opposite end of the inner part 105 from the inner locking structure 165 and the inner stop structure 175.

In exemplary embodiments, the outer part 111 can be formed from the outer blank 109 as shown in at least FIGS. 5-7. For example, the distal outer locking panel 269b and the distal outer stop panel 279b can be folded along the respective longitudinal fold lines 271, 281 to be in an overlapping relationship with the respective proximal outer locking panel 269a and proximal outer stop panel 279a (e.g., so that the interior surfaces of the distal outer locking panel 269b and the distal outer stop panel 279b are in face-to-face contact with the interior surfaces of the respective proximal outer locking panel 269a and proximal outer stop panel 279a). In embodiments, the distal outer locking panel 269b and the distal outer stop panel 279b can be secured (e.g., glued) to the respective proximal outer locking panel 269a and proximal outer stop panel 279a, such as by glue spots and/or glue strips G4 on the interior surfaces of the distal outer locking panel 269b, the distal outer stop panel 279b, the proximal outer locking panel 269a, and/or proximal outer stop panel 279a. As shown in FIG. 5, the outer locking structure 265 and the outer stop structure 275 can be folded along the respective longitudinal fold lines 267, 277 over the interior surface 108 of the outer blank 109 (e.g., so that the proximal outer locking panel 269a and the distal outer locking panel 269b are in face-to-face contact with the interior surface of the first outer side panel 223 and that the proximal outer stop panel 279a and the distal outer stop panel 279b are in face-to-face contact with the interior surface of the second outer side panel 227). In the illustrated embodiments, the proximal outer locking panel 269a and the proximal outer stop panel 279a can be secured (e.g., adhered) to the respective outer side panels 223, 227, such as with glue spots or glue strips G5 on the interiors of the proximal outer locking panel 269a and the proximal outer stop panel 279a (FIG. 2). In embodiments, the distal outer locking panel 269b and the distal outer stop panel 279b could be secured to the respective outer side panels 223, 227 or could remain unsecured to the remainder of the outer blank 109. Accordingly, the outer locking structure 265 and the outer stop structure 275 are secured to respective outer side panels 223, 227 (e.g., via glue strips G5) on the interior 108 of the outer blank 109 and the proximal outer locking panel 269a and the proximal outer stop panel 279a are secured to the respective distal outer locking panel 269b and distal outer stop panel 279b (e.g., via glue strips G4).

As shown in FIGS. 6 and 7, the outer part 111 further can be formed by folding the plurality of outer panels 221, 223, 227, 231 to extend at least partially around the receiving space 115 (FIG. 7), which can at least partially receive the inner part 105 (FIGS. 8-11). In exemplary embodiments, the outer attachment flap 235 can be attached (e.g., glued) in face-to-face contact with an interior surface of the outer bottom panel 231, such as with one or more glue strips G6 on the exterior surface of the outer attachment flap 235 and/or the interior surface of the outer bottom panel 231.

In the illustrated embodiments, the first outer end 291 of the outer part 111 can be an at least partially open end with the outer locking structure 265 and the outer stop structure 275 extending from the outer open end 291 along the interior receiving space 115 of the outer part 111. For example, the longitudinal fold lines 267, 277 and the free edges of the outer top panel 221 and the outer bottom panel 227 can extend along the open end 291, and the recesses 305, 307 can extend from the open end 291.

As shown in FIGS. 6 and 7, the outer end flaps 241, 245, 247, 249 can be folded and overlapped to at least partially close the second outer end 293 of the outer part 111. In the illustrated embodiments, the outer side end flaps 245, 247 can be folded over the second outer end 293 of the outer part 111, the outer bottom end flap 249 can be folded over the end to at least partially overlap the outer side end flaps 245, 247, and the outer top end flap 241 can be folded to overlap the outer bottom end flap 249. In embodiments, two or more of the outer end flaps 245, 247, 249, 241 can be secured (e.g., adhered) to one another. For example, the inner surface of the outer top end flap 241 can be glued and/or otherwise secured to the exterior surface of the outer bottom end flap 249. The outer part 111 could be otherwise formed and/or the outer ends 291, 293 could remain at least partially open and/or could be otherwise closed without departing from the disclosure.

In exemplary embodiments, the carton 113 can be formed by forming the outer part 111 around the inner part 105 (e.g., folding the outer blank 109 around the erected inner part 105). In other embodiments, the inner part 105 and the outer part 111 can be erected separately, and the inner part 105 can be inserted into the receiving space 115 of the outer part 111 via the open outer end 291. For example, the inner part 105 and the outer part 111 can be oriented with the inner top panel 121 and the outer top panel 221 facing upwardly, and the second inner end 193 of the inner part 105 can be inserted into the open outer end 291 of the outer part 111. In embodiments, the inner part 105 can slide into the receiving space 115 of the outer part 111 with the inner locking structure 165 and the inner stop structure on the exterior of the inner part 105 sliding along the respective outer locking structure 265 and outer stop structure 275 on the interior of the outer part 111. Since the outer stop structure 275 is shorter that the outer locking structure 265 (e.g., the outer locking structure 265 extends to a point that is closer to the closed outer end 293 than the outer stop structure 275), the second inner end 193 and the inner stop structure 175 first slide past the outer stop structure and the inner stop structure 175 continues to slide along the second outer side panel 237 as the inner part 105 is moved into the receiving space 115. As the second inner end 193 approaches the closed outer end 293, the inner locking structure 165 can slide past the outer locking structure 265 and the inner locking structure 165 can move outwardly against the first outer side panel 223. In embodiments, the inner locking structure 165 can snap outwardly against the outer side panel 223, making a noise (e.g., a click, snap, etc.) that indicates that the carton 113 is fully closed and locked (FIG. 8). In embodiments, the locking structures 165, 265 can be located between the first inner side panel 123 and the first outer side panel 223 (e.g., the locking structures 165, 265 can be sandwiched between the side panels 123, 223) when the carton 113 is in the closed configuration. Similarly, the stop structures 175, 275 can be located between the second inner side panel 127 and the second outer side panel 227 (e.g., the stop structures 175, 275 can be sandwiched between the side panels 127, 227) when the carton 113 is in the closed configuration.

In the illustrated embodiments, when the carton 113 is in the fully closed configuration (FIG. 8), the inner part 105 can be in a first position wherein the inner locking structure 165 can be aligned with the outer locking structure 265 with an inner locking edge 325 of the inner locking structure 165 positioned opposite to an outer locking edge 327 of the outer locking structure 265. For example, the inner locking edge 325 can extend along/correspond to the longitudinal fold line 171 connecting the proximal inner locking panel 169a and the distal inner locking panel 169b and the outer locking edge 327 can extend along/correspond to the longitudinal fold line 271 connecting the proximal outer locking panel 269a and the distal locking panel 269b. Stated another way, the longitudinal fold line 171 can at least partially form the inner locking edge 325 when the inner locking panels 169a, 169b are folded into overlapping relationship, and the longitudinal fold line 271 can at least partially form the outer locking edge 327 when the outer locking panels 269a, 269b are folded into overlapping relationship. In embodiments, attempting to remove the inner part 105 from the receiving space 115 via the outer open end 291 can be resisted and/or prevented by the engagement of the locking structures 165, 265, wherein the locking edges 325, 327 engage/contact one another and resist and/or prevent relative movement between the inner part 105 and the outer part 111. Accordingly, the locking structures 165, 265 can cooperate to help resist and/or prevent opening of the carton 113 by attempting to pull the inner part 105 out of the outer part 111.

As shown in FIGS. 9-11, the carton 113 can be opened by disengaging the locking structures 165, 265, sliding the inner part 105 partially out of the receiving space 115 of the outer part 111, and opening the dispenser 117, for example. In embodiments, the access feature 311 can be actuated to provide access to the inner locking structure 165 via the outer side panel 223. For example, the access flap 313 can be grasped at the access cutout 319 and can be pulled outwardly relative to the outer side panel 223 to separate the access flap 313 from the outer side panel 223 along the tear line 317 and to fold the access flap 313 outwardly along the fold line 315, forming the access opening 321 (FIG. 9). As shown in FIG. 9, a user can press inwardly on the inner locking structure 165 via the access opening 321 so that the inner locking structure 165 presses inwardly on the inner side tab 172 in the inner side panel 123. In embodiments, the inner side tab 172 can move into the interior 323 of the inner part 105, separating from a remainder of the inner side panel 123 along the cut 173 extending proximate to the inner locking edge 325 of the inner locking structure 165. This action can move the inner locking edge 325 out of alignment with the outer locking edge 327 so that the inner locking structure 165 is disengaged from the outer locking structure 265, which can allow the inner part 105 to slide relative to the outer part 111 within the receiving space 115. Accordingly, with the inner locking structure 165 pressed inwardly via the access feature 311, the inner part 105 can be grasped (e.g., via the access recesses 305, 307) and pulled outwardly from the first position (FIG. 8) through the open outer end 293 of the outer part 111 to a second position of the inner part 105 (FIGS. 10-11). Once the inner locking edge 325 moves past the outer locking edge 327, the inward pressure on the inner locking structure 165 via the access feature 311 can be released and the inner locking structure 165 can slide along the inner surface of the outer locking structure 265 as the inner part 105 continues to be moved outwardly through the open end 293 (FIG. 10A).

In embodiments, a user can continue to pull the inner part outwardly relative to the outer part 111 until the inner part 105 is in the second position and the inner stop structure 175 engages the outer stop structure 275 (FIG. 10B). Similar to the interaction between the locking structures 165, 265, the inner stop structure 175 can be aligned with the outer stop structure 275 with an inner stop edge 329 of the inner stop structure 175 positioned opposite to an outer stop edge 331 of the outer stop structure 275. For example, the inner stop edge 329 can extend along/correspond to the longitudinal fold line 181 connecting the inner stop panels 179a, 179b and the outer stop edge 331 can extend along/correspond to the longitudinal fold line 281 connecting the outer stop panel 279a, 279b. Stated another way, the longitudinal fold line 181 can at least partially form the inner stop edge 329 when the inner stop panels 179a, 179b are folded into overlapping relationship, and the longitudinal fold line 281 can at least partially form the outer stop edge 331 when the outer stop panels 279a, 279b are folded into overlapping relationship. In embodiments, the engagement of the stop structures 175, 275 can resist and/or prevent further movement of the inner part 105 out of the receiving space 115 of the outer part 111 via the open end 293. In embodiments, the stop edges 329, 331 can engage/contact one another and resist and/or prevent relative movement between the inner part 105 and the outer part 111 that would otherwise remove the inner part 105 from the outer part 111 via the open end 293. Accordingly, the stop structures 175, 275 can cooperate to help resist and/or prevent further and/or complete removal of the inner part 105 from the outer part 111.

As shown in FIG. 11, the carton 113 can be in an open configuration with the inner part 105 partially removed from the outer part 111. For example, the dispenser 117 can be moved out of the receiving space 115 of the outer part 111 so that a user can open the inner part 105 by actuating the dispenser 117. In the illustrated embodiments, the dispenser 117 can be opened by tearing the tear line 195 to at least partially separate the dispenser structure 201 from a remainder of the inner part 105 and by pivoting the dispenser structure 201 away from the remainder of the inner part 105 along the hinge formed by the longitudinal fold lines 197, 199 in the inner bottom panel 131 and the attachment flap 135. With the dispenser 117 open as shown in FIG. 11 to at least partially form a dispenser opening 333, a user can access the interior 323 of the inner part 105 to remove one or more products P via the dispenser opening 333 and/or to add articles to the interior 323. In embodiments, the dispenser 117 can be returned to the closed configuration prior to reclosing the carton 113 as described below.

In the illustrated embodiments, the carton 113 can be returned from the open configuration (FIGS. 10A-11) to the closed configuration (FIG. 8) by pressing inwardly on the inner part 105 to move the inner part 105 relative to the outer part 111, such as until the inner locking structure 165 fully passes the outer locking structure 265. In embodiments, the inner locking structure 165 can make a snapping/clicking sound when it moves outwardly against the outer side panel 223 after passing the outer locking structure 265, providing an audio cue that the inner part 105 is locked in the receiving space 115 of the outer part 111 (e.g., the locking structures 165, 265 are in a locking configuration so that the locking edges 325, 327 will engage and resist and/or prevent movement of the inner part 105 out of the outer part 111.

In embodiments, the outer part 111 can help prevent reopening of the dispenser 117 when the carton 113 is in the closed configuration. For example, the tight fit of the dispenser structure 201 in the receiving space 115 of the outer part 111 can resist and/or prevent pivoting of the dispenser structure 201 even after the tear line 195 has been torn (e.g., when the dispenser 117 has been previously actuated). In exemplary embodiments, the torn tear line 317 can provide tamper evidence for the carton 113. For example, an observer can see that the tear line 317 has been torn, indicating that the carton 113 may have been opened and its contents accessed (e.g., tampered with and/or removed). The carton 113 could be otherwise formed, opened, reclosed, etc. without departing from the disclosure.

The locking and/or stop (retention) components of at least the illustrated embodiments of the present disclosure can be strategically formed and located within the structure of the carton for facilitating the retention of products in the interior of the carton, for facilitating case of transport of the carton (e.g., when the carton has been reclosed after initial opening), and/or for helping secure the product against accidental, unintended, and/or unauthorized access. For example, the locking features can be sized and located so that the locking edges can be aligned for engagement and/or in contact with one another when the carton is in its closed configuration. In exemplary embodiments, the locking engagement of the carton components (e.g., of the outer part and the inner part) can resist and/or prevent accidental opening and/or resist and/or prevent opening of the carton by a child. For example, a child may not have the knowledge and/or the dexterity to open the carton when it is fully closed. In exemplary embodiments, the structures of the cartons can provide a deterrent to children to open the packaging while allowing an adult to utilize key features of the packaging to easily access the contents in the packaging with little effort. In embodiments, the carton can provide an audio cue to a user when the inner part is moved to its fully closed configuration to alert the user that the locking features are engaged and the carton is in a child resistant configuration to help prevent a child from accessing the contents of the carton. In the illustrated embodiments, various features of the cartons can provide tamper evidence in the event that the carton was opened and/or was attempted to be opened previously. For example, features of the cartons can be at least partially removed and/or torn to initially open the carton and providing evidence that the carton was opened. Such tamper evidence may provide the user with an indication that the contents of the carton may have been accessed prior to intended use. In embodiments, features of the cartons can have natural spring back functions to help maintain pressure during opening processes.

In general, the blanks of the present disclosure may be constructed from paperboard having a caliper so that it is heavier and more rigid than ordinary paper. The blank can also be constructed of other materials, such as cardboard, or any other material having properties suitable for enabling the carton to function at least generally as described above. The blank can be coated with, for example, a clay coating. The clay coating may then be printed over with product, advertising, and other information or images. The blanks may then be coated with a varnish to protect information printed on the blanks. The blanks may also be coated with, for example, a moisture barrier layer, on either or both sides of the blanks. The blanks can also be laminated to or coated with one or more sheet-like materials at selected panels or panel sections.

As an example, a tear line can include: a slit that extends partially into the material along the desired line of weakness, and/or a series of spaced apart slits that extend partially into and/or completely through the material along the desired line of weakness, or various combinations of these features. As a more specific example, one type tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the tear lines to be replaced with a continuous slit, or the like. For example, a cut line can be a continuous slit or could be wider than a slit without departing from the present disclosure.

In accordance with the exemplary embodiments, a fold line can be any substantially linear, although not necessarily straight, form of weakening that facilitates folding there along. More specifically, but not for the purpose of narrowing the scope of the present disclosure, fold lines include: a score line, such as lines formed with a blunt scoring knife, or the like, which creates a crushed or depressed portion in the material along the desired line of weakness; a cut that extends partially into a material along the desired line of weakness, and/or a series of cuts that extend partially into and/or completely through the material along the desired line of weakness; and various combinations of these features. In situations where cutting is used to create a fold line, typically the cutting will not be overly extensive in a manner that might cause a reasonable user to incorrectly consider the fold line to be a tear line.

The above embodiments may be described as having one or more panels adhered together by glue during erection of the carton embodiments. The term “glue” is intended to encompass all manner of adhesives commonly used to secure carton panels in place.

The foregoing description of the disclosure illustrates and describes various embodiments. As various changes could be made in the above construction without departing from the scope of the disclosure, it is intended that all matter contained in the above description or shown in the accompanying drawings shall be interpreted as illustrative and not in a limiting sense. Furthermore, the scope of the present disclosure covers various modifications, combinations, alterations, etc., of the above-described embodiments. Additionally, the disclosure shows and describes only selected embodiments, but various other combinations, modifications, and environments are within the scope of the disclosure as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A carton for holding one or more products, the carton comprising:
an inner part comprising a plurality of inner panels extending at least partially around an interior of the inner part, the plurality of inner panels comprising at least a first inner side panel and a second inner side panel opposite to the first inner side panel, the inner part further comprising an inner locking structure foldably connected to the first inner side panel and an inner stop structure foldably connected to the second inner side panel;
an outer part comprising a plurality of outer panels extending at least partially around at least a portion of the inner part, the plurality of outer panels comprising at least a first outer side panel and a second outer side panel, the outer part further comprising an outer locking structure foldably connected to the first outer side panel and an outer stop structure foldably connected to the second outer side panel; and
a dispenser extending in the inner part, the dispenser being configured for being actuated to provide access to the interior of the inner part;
wherein the inner locking structure and the outer locking structure cooperate to limit movement between the inner part and the outer part when the inner part is in a first position;
wherein at least the inner locking structure is moveable with respect to the outer locking structure for allowing the inner part to move relative to the outer part from the first position at least partially through an open end of the outer part to a second position, and the inner stop structure and the outer stop structure cooperate to limit movement of the inner part through the open end of the outer part when the inner part is in the second position.

2. The carton of claim 1, wherein the dispenser of the inner part is located within the outer part when the inner part is in the first position so that the outer part at least partially restricts access to the dispenser in the first position of the inner part, and the dispenser is exterior to the outer part when the inner part is in the second position so that the dispenser is accessible in the second position of the inner part.

3. The carton of claim 1, wherein the plurality of inner panels further comprises an inner top panel and an inner bottom panel, and wherein the dispenser comprises a tear line extending in the inner top panel, the first inner side panel, and the second inner side panel, and the dispenser comprises a fold line extending in the bottom panel.

4. The carton of claim 1, wherein the dispenser extends along a first end of the inner part, and the inner locking structure and the inner stop structure extend from an opposing second end of the inner part.

5. The carton of claim 1, wherein a first inner side end flap is foldably connected to the locking structure and a second inner side end flap is foldably connected to the inner stop structure, and wherein the first inner side end flap and the second inner side end flap at least partially close an end of the inner part.

6. The carton of claim 1, wherein:
the inner locking structure comprises a first inner locking panel foldably connected to a second inner locking panel along a first fold line, the first inner locking panel at least partially overlaps the first inner side panel, the second inner locking panel at least partially overlaps the first inner locking panel, and the first fold line at least partially forms an inner locking edge;
the outer locking structure comprises a first outer locking panel foldably connected to a second outer locking panel along a second fold line, the first outer side panel at least partially overlaps the first outer locking panel and the second outer locking panel, the second outer locking panel at least partially overlaps the first outer locking panel, and the second fold line at least partially forms an outer locking edge; and
the inner locking structure is aligned with the outer locking structure with the inner locking edge positioned opposite to the outer locking edge when the inner part is in the first position.

7. The carton of claim 6, wherein:
the inner locking structure at least partially overlaps an inner side tab at least partially defined by a cut extending in the first inner side panel;
the outer part comprises an access feature extending in the first outer side panel, the access feature is at least partially aligned with the inner locking structure when the inner part is in the first position; and
the access feature and the inner side tab facilitate moving the inner locking structure out of alignment with the outer locking structure.

8. The carton of claim 1, wherein:
the inner stop structure comprises a first inner stop panel foldably connected to a second inner stop panel along a first fold line, the first inner stop panel at least partially overlaps the second inner side panel, the second inner stop panel at least partially overlaps the first inner stop panel, and the first fold line at least partially forms an inner stop edge;
the outer stop structure comprises a first outer stop panel foldably connected to a second outer stop panel along a second fold line, the second outer side panel at least partially overlaps the first outer stop panel and the second outer stop panel, the second outer stop panel at least partially overlaps the first outer stop panel, and the second fold line at least partially forms an outer stop edge; and
the inner stop structure is aligned with the outer stop structure with the inner stop edge positioned opposite to the outer stop edge.

9. The carton of claim 1, wherein the outer locking structure is longer than the outer stop structure.

10. The carton of claim 9, wherein the inner locking structure and the inner stop structure are similar or identical in length to one another.

11. In combination, a first blank and a second blank for cooperating to at least partially form a carton,
the first blank comprising a plurality of inner panels, an inner locking structure, and an inner stop structure, the plurality of inner panels comprising at least a first inner side panel and a second inner side panel, and dispenser features extend in the plurality of panels, wherein the inner locking structure is foldably connected to the first inner side panel and the inner stop structure is foldably connected to the second inner side panel, and wherein the first blank is for forming an inner part having an interior and the dispenser features are for forming a dispenser in the inner part formed from the first blank;
the second blank comprising a plurality of outer panels, an outer locking structure, and an outer stop structure, the plurality of outer panels comprising at least a first outer side panel and a second outer side panel, wherein the outer locking structure is foldably connected to the first outer side panel and the outer stop structure is foldably connected to the second outer side panel, and wherein the second blank is for forming an outer part with the plurality of outer panels at least partially extending around the inner part formed from the first blank;
wherein the inner locking structure and the outer locking structure are configured for cooperating to limit movement between the inner part formed from the first blank and the outer part formed from the second blank when the carton is formed from the first blank and the second blank and when the inner part formed from the first blank is in a first position;
wherein the inner stop structure and the outer stop structure are configured for cooperating to limit movement of the inner part formed from the first blank relative to the outer part formed from the second blank when the carton is formed from the first blank and the second blank and when the inner part formed from the first blank is in a second position.

12. The combination of claim 11, wherein the plurality of inner panels further comprises an inner top panel and an inner bottom panel, and wherein the dispenser features comprise a tear line extending in the inner top panel, the first inner side panel, and the second inner side panel, and the dispenser features comprise a fold line extending in the bottom panel.

13. The combination of claim 11, wherein the inner locking structure and the inner stop structure are spaced apart from the dispenser features so that, when the inner part is formed from the blank, the dispenser extends along an opposing end of the inner part from the the inner locking structure and the inner stop structure.

14. The combination of claim 11, wherein the first blank further comprises a first inner side end flap foldably connected to the locking structure and a second inner side end flap foldably connected to the inner stop structure, and wherein the first inner side end flap and the second inner side end flap are for at least partially closing an end of the inner part formed from the first blank.

15. The combination of claim 11, wherein:
the inner locking structure comprises a first inner locking panel foldably connected to a second inner locking panel along a first fold line, and the first fold line is for at least partially forming an inner locking edge when the inner part is formed from the first blank;
the outer locking structure comprises a first outer locking panel foldably connected to a second outer locking panel along a second fold line, and the second fold line is for at least partially forming an outer locking edge when the outer part is formed from the second blank; and
the inner locking structure is for being aligned with the outer locking structure with the inner locking edge positioned opposite to the outer locking edge when the carton is formed from the first blank and the second blank and the inner part formed from the first blank is in the first position.

16. The combination of claim 11, wherein:
the inner stop structure comprises a first inner stop panel foldably connected to a second inner stop panel along a first fold line, and the first fold line is for at least partially forming an inner stop edge when the inner part is formed from the first blank;
the outer stop structure comprises a first outer stop panel foldably connected to a second outer stop panel along a second fold line, and the second fold line at least partially forms an outer stop edge when the outer part is formed from the second blank; and
the inner stop structure is for being aligned with the outer stop structure with the inner stop edge positioned opposite to the outer stop edge when the carton is formed from the first blank and the second blank.

17. The combination of claim 11, wherein the outer locking structure is longer than the outer stop structure.

18. The combination of claim 17, wherein the inner locking structure and the inner stop structure are similar or identical in length to one another.

19. A method of forming a carton, the method comprising:
obtaining a first blank comprising a plurality of inner panels, an inner locking structure, and an inner stop structure, the plurality of inner panels comprising at least a first inner side panel and a second inner side panel, and dispenser features extend in the plurality of panels, wherein the inner locking structure is foldably connected to the first inner side panel and the inner stop structure is foldably connected to the second inner side panel;
forming an inner part from the first blank by folding the plurality of inner panels at least partially around an interior of the inner part, the dispenser features forming a dispenser of the inner part, the dispenser being configured for being actuated to provide access to the interior of the inner part;
obtaining a second blank comprising a plurality of outer panels, an outer locking structure, and an outer stop structure, the plurality of outer panels comprising at least a first outer side panel and a second outer side panel, wherein the outer locking structure is foldably connected to the first outer side panel and the outer stop structure is foldably connected to the second outer side panel; and
forming an outer part from the second blank, the inner part being located at least partially within the outer part so that the outer panels extend at least partially around the inner part, the outer part comprising a second opening;
wherein the inner locking structure and the outer locking structure cooperate to limit movement between the inner part and the outer part when the inner part is in a first position;
wherein at least the inner locking structure is moveable with respect to the outer locking structure for allowing the inner part to move relative to the outer part from the first position at least partially through an open end of the outer part to a second position, and the inner stop structure and the outer stop structure cooperate to limit movement of the inner part through the open end of the outer part when the inner part is in the second position.

20. The method of claim 19, wherein the dispenser of the inner part is located within the outer part when the inner part is in the first position so that the outer part at least partially restricts access to the dispenser in the first position of the inner part, and the dispenser is exterior to the outer part when the inner part is in the second position so that the dispenser is accessible in the second position of the inner part.

21. The method of claim 19, wherein the first blank further comprises a first inner side end flap foldably connected to the locking structure and a second inner side end flap foldably connected to the inner stop structure, and wherein the forming the inner part further comprises folding the first inner side end flap and the second inner side end flap to at least partially close an end of the inner part.

22. The method of claim 19, wherein:
the inner locking structure comprises a first inner locking panel foldably connected to a second inner locking panel along a first fold line;
the forming the inner part further comprises positioning the first inner locking panel to at least partially overlap the first inner side panel and folding the second inner locking panel along the first fold line to at least partially overlap the first inner locking panel, the first fold line at least partially forming an inner locking edge;
the outer locking structure comprises a first outer locking panel foldably connected to a second outer locking panel along a second fold line;
the forming the outer part further comprises folding the second outer locking panel along the second fold line to at least partially overlap the first outer locking panel and positioning the outer locking structure so that the first outer side panel at least partially overlaps the first outer locking panel and the second outer locking panel, the second fold line at least partially forming an outer locking edge; and
the inner locking structure is aligned with the outer locking structure with the inner locking edge positioned opposite to the outer locking edge when the inner part is in the first position.

23. The method of claim 22 wherein:
the inner locking structure at least partially overlaps an inner side tab at least partially defined by a cut extending in the first inner side panel;
the outer part comprises an access feature extending in the first outer side panel, the access feature is at least partially aligned with the inner locking structure when the inner part is in the first position; and
the access feature and the inner side tab facilitate moving the inner locking structure out of alignment with the outer locking structure.

24. The method of claim 19, wherein:
the inner stop structure comprises a first inner stop panel foldably connected to a second inner stop panel along a first fold line;
the forming the inner part further comprises positioning the first inner stop panel to at least partially overlap the second inner side panel and folding the second inner stop panel along the first fold line to at least partially overlap the first inner stop panel, the first fold line at least partially forming an inner stop edge;
the outer stop structure comprises a first outer stop panel foldably connected to a second outer stop panel along a second fold line;
the forming the outer part further comprises folding the second outer stop panel along the second fold line to at least partially overlap the first outer stop panel and positioning the outer stop structure so that the second outer side panel at least partially overlaps the first outer stop panel and the second outer stop panel, the second fold line at least partially forming an outer stop edge; and
the inner stop structure is aligned with the outer stop structure with the inner stop edge positioned opposite to the outer stop edge.
